(19) United States
(12) Patent Application Publication
(10) Pub. No.: US 2018/0210937 A1
(43) Pub. Date: Jul. 26, 2018

(54) DATA SYNCHRONIZATION METHOD AND APPARATUS

(71) Applicant: ALIBABA GROUP HOLDING LIMITED, George Town (KY)

(72) Inventor: Hanfa SHI, Hangzhou (CN)

(73) Assignee: ALIBABA GROUP HOLDING LIMITED

(21) Appl. No.: 15/933,793

(22) Filed: Mar. 23, 2018

Related U.S. Application Data
(63) Continuation of application No. PCT/CN2016/099054, filed on Sep. 14, 2016.

(30) Foreign Application Priority Data
Sep. 25, 2015 (CN) 201510625059.4

(51) Int. Cl. G06F 17/30

(52) U.S. Cl. CPC G06F 17/30575; G06F 17/30595; G06F 17/30569

(57) ABSTRACT

Embodiments of the present application provide a data synchronization method and apparatus. The method includes: acquiring source data from a source database; converting the source data into to-be-synchronized data matching a data meta format of a target database; synchronizing the to-be-synchronized data to the target database; determining whether dirty data has been detected during the synchronization; and in response to the dirty data being detected during the synchronization, skipping the detected dirty data to continue with synchronizing the to-be-synchronized data.

### CROSS REFERENCE TO RELATED APPLICATION

The disclosure claims the benefits of priority to International Application No. PCT/CN2016/099054, filed on Sep. 14, 2016 which is based on and claims the benefits of priority to Chinese Application No. 201510625059.4, filed on Sep. 25, 2015, both of which are incorporated herein by reference in their entireties.

### BACKGROUND

In the big data environment, an increasing number of enterprises realize that big data is an important information treasure trove to be mined. However, various devices and various services of an enterprise use different meta structures for storing data. In other words, different databases are employed. For example, various types of databases can include MySQL, Oracle, SQLServer, PostgreSQL, DRDS, OceanBase, ODPS, and Hbase.

To collect, process, and analyze the foregoing heterogeneous environment data, it is necessary to establish data synchronization in a heterogeneous data source environment to implement interconnection of all data; that is, synchronize data of one or more source databases into a target database.

Conventionally, synchronization of source data is mainly implemented by using a synchronization tool. Taking a relational database, such as MySQL, Oracle, SQLserver, and PostgreSQL, as an example, steps for synchronizing source data to the relational database generally include: converting source data into a standard SQL sentence; inserting the standard SQL sentence into a target database; and reporting, via a program, an error and quitting when dirty data has been detected during synchronization.

The dirty data can include the source data inconsistent with target data in the target database. For example, the dirty data can include a primary key of the source data conflicting with that of the target data, a data type of the source data not matching that of the target data, and the like.

In the foregoing process, once dirty data is detected during the source data, the synchronization process cannot proceed. However, synchronization of big data generally consumes a substantial amount of resources. Therefore, the foregoing process undoubtedly wastes an extremely large quantity of resources of a machine, is unable to tolerate errors, and increases the total time for synchronization.

### SUMMARY

In view of the foregoing problems, embodiments of the present application are proposed to provide a data synchronization method and a corresponding data synchronization apparatus that overcome the foregoing problems or at least partially solve the foregoing problems.

To solve the foregoing problems, embodiments of the present application discloses a data synchronization method. The data synchronization method can include: acquiring source data from a source database; converting the source data into to-be-synchronized data matching a data meta format of a target database; synchronizing the to-be-synchronized data to the target database piece by piece, and judging whether dirty data has been detected; and continuing, if dirty data has been detected, to synchronize to-be-synchronized data after the dirty data.

The present application further discloses a data synchronization apparatus, including: a source data acquisition module configured to acquire source data from a source database; a conversion module configured to convert the source data into to-be-synchronized data matching a data meta format of a target database; a synchronization judgment module configured to synchronize the to-be-synchronized data to the target database piece by piece, and judge whether dirty data has been detected; and a continuing module configured to continue, if dirty data has been detected, to synchronize to-be-synchronized data after the dirty data.

In some embodiments of the present application, a fault tolerant mechanism may be preset. When dirty data has been detected, the fault tolerant mechanism can implement a process of continuing to synchronize to-be-synchronized data after the dirty data, thereby preventing the dirty data from affecting the synchronization process. It is unnecessary to exit the program once dirty data is detected during the synchronization process, so that synchronization can be continued, thus reducing the waste of machine resources; the synchronization program does not need to be restarted repeatedly, thus reducing synchronization time.

### BRIEF DESCRIPTION OF THE DRAWINGS

FIG. 1 is a flowchart of an exemplary data synchronization method according to embodiments of the present application.

FIG. 2 is a flowchart of another exemplary data synchronization method according to embodiments of the present application.

FIG. 3A is a flowchart of yet another exemplary data synchronization method according to embodiments of the present application.

FIG. 3B is an example of a DataX frame according to embodiments of the present application.

FIG. 4 illustrates a structural block diagram of an exemplary data synchronization apparatus according to the present application.

FIG. 5 illustrates a structural block diagram of another exemplary data synchronization apparatus according to embodiments of the present application.

FIG. 6 illustrates a structural block diagram of yet another exemplary data synchronization apparatus according to embodiments of the present application.

### DETAILED DESCRIPTION

To make the foregoing objectives, features, and advantages of the present application easier to understand, the present application is described in further detail with reference to the accompanying drawings and specific implementations.

The embodiments of the present disclosure provide a more efficient data synchronization method and system. For example, embodiments of the present application can provide a preset fault tolerant mechanism. The fault tolerant mechanism can prevent dirty data from affecting the synchronization process. It is unnecessary to exit the program once dirty data is detected during the synchronization process, so that synchronization can be continued. Thus the waste of machine resources can be reduced, and the synchronization program does not need to be restarted repeatedly, thus reducing synchronization time.

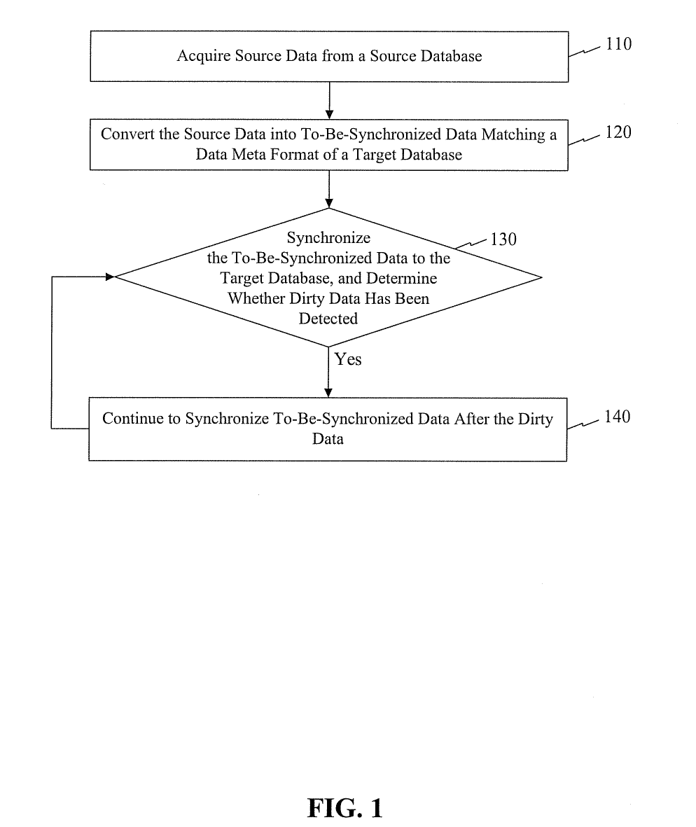

FIG. 1 is a flowchart of an exemplary data synchronization method according to embodiments of the present application. The method may include the following steps 110-140.

In step 110, source data can be acquired from a source database. The source database mentioned in embodiments of the present application may be any type of relational database, and a target database mentioned in embodiments of the present application may be any type of relational database. The source database and the target database in embodiments of the present application may be other types of databases, which are not limited in the present application. The relational database can include, for example, MySQL, Oracle, SQLserver, PostgreSQL, or the like.

Embodiment of the present application may be applied to a DataX frame. The DataX, which encapsulates conversion rules between various types of databases, is a tool for high-speed data exchange between heterogeneous databases/file systems and implements data exchange between any data processing systems.

In some embodiments, a user may configure a synchronization job. For example, in a DataX frame, the user may input a command (e.g., /home/taobao/datax/bin/datax.py-e command) to select a source database and a target database in a source database interface. And a target database interface can, for example, select a database (e.g., a SQLserver) as the source database and select another database (e.g., an Oracle database) as the target database. Then, the user configures a corresponding configuration file in a Json format (e.g., job.json) for the synchronization job. The file job.json can include the range of source data to be synchronized.

It is appreciated that, after configuring the job, the user may start a synchronization process, and then the file job.json can be loaded, so that source data can be acquired from the source database according to the configuration in job.json.

Embodiment of the present application may further employ other synchronization tools, which are not limited in embodiments of the present application.

In some embodiments of the present application, before step 110, the method further includes a step 101.

In step 101, a synchronization job task can be decomposed into at least two sub-tasks.

In embodiments of the present application, one synchronization job task may be decomposed into multiple sub-tasks, so that a parallel speed can be improved. Therefore, synchronization efficiency can also be improved.

It can be understood that the synchronization job task may be decomposed according to tables that need to be synchronized, and each sub-task processes a table. For example, the synchronization job task may process synchronization for multiple tables. For example, each sub-task can process one table. Alternatively, decomposition may be carried out according to the total number of rows to be synchronized, and each sub-task processes a certain proportion of the rows. For example, 50,000 rows of Table 1, 30,000 rows of Table 2, and 10,000 rows of Table 3 in the source database need to be synchronized, and each sub-task is responsible for synchronizing 30,000 rows. Thus, sub-task 1 may synchronize the first 30,000 rows of Table 1, sub-task 2 may synchronize 30,000 rows of Table 2, and sub-task 3 may synchronize the remaining 20,000 rows of Table 1 and 10,000 rows of Table 3.

It should be noted that the synchronization job task may also be decomposed according to a requirement, and the decomposition strategy thereof is not limited in embodiments of the present application.

In some embodiments, for the DataX frame, a MasterContainer module may be started. MasterContainer is a central management node of a single DataX job, and may load the foregoing configuration file and perform functions, such as data cleaning and converting a single synchronization job task into multiple sub-tasks. Therefore, in embodiments of the present application, the MasterContainer module of DataX may decompose the synchronization job task into at least two sub-tasks.

On the basis of step 101, in some embodiments of the present application, step 110 includes: a sub-step A111.

In sub-step A111, each sub-task separately acquires, from the database, source data to be processed by the sub-task itself.

It is appreciated that, because the synchronization job task is decomposed into multiple sub-tasks and each sub-task has its own processing target, each sub-task in embodiments of the present application can acquire, from the database, source data to be processed by the sub-task itself.

In the DataX frame, the MasterContainer module is started first, and after the MasterContainer module decomposes the synchronization job task into multiple sub-tasks, a Scheduler module can be called. The Scheduler module can start a scheduling task. The scheduling task controls running of each sub-task. The scheduling task can start multiple SlaveContainer modules. Each SlaveContainer module can load a corresponding type of reader plug-in according to the type of the source database. The reader plug-in can read, from the database according to a data meta structure of this type of database, source data required by the synchronization sub-task.

In step 120, the source data can be converted into to-be-synchronized data matching a data meta format of a target database. For example, if the source database from which the source data is extracted is Oracle and the target database to which the source data is synchronized is MySQL, the source data in Oracle may be converted into a SQL sentence adaptive to MySQL.

In some embodiments, for the DataX frame, the source data may be input to a data exchange module Storage in the DataX frame. The data exchange module can covert, according to the type of the source database and the type of the target database, the source data into the to-be-synchronized data adaptive to a data meta structure of the target database.

In some embodiments of the present application, before step 130, the method further includes a step 121.

In step 121, the to-be-synchronized data can be pre-detected to filter out dirty data in the to-be-synchronized data. In embodiments of the present application, data pre-detection processing may be performed before data synchronization to avoid dirty data. In some embodiments, pre-detected dirty data may also be recorded. For example, before synchronization, data matching is performed between all data to be synchronized and the target database. The data matching can include, for example, matching of corresponding field types, primary key matching, and so on, so that the data to be synchronized completely meets requirements of the target database.

After the step is performed, if there is no dirty data in the to-be-synchronized data, synchronization may be performed without performing a dirty data determination process to complete synchronization. If not all dirty data are filtered out, determination on dirty data occurring in the synchronization process may be continued.

In step 130, the to-be-synchronized data may be synchronized to the target database, and it is determined whether dirty data has been detected.

During a writing process, the to-be-synchronized data is gradually written into the target database, and when one piece of data fails to be written into the target database, this piece of data may be considered as dirty data.

During a writing process, it may be determined, according to an error reported by the target database, whether the piece of written data is dirty data. For example, the piece of data may conflict with a primary key of a table of the target database during writing. It is assumed that Table 1 in the target database is as follows.

TABLE 1

| ID | City_ID |
|---|---|
| 1 | 2 |
| 2 | 3 |
| 5 | 4 |
| 4 | 5 |

In some embodiments, the ID column in Table 1 may not allow repetition. Therefore, for example, when a piece of to-be-synchronized data is going to modify the ID value of the third row to 4, a primary key conflict may occur because the value 4 already exists in the ID column while the ID column does not allow repetition.

In some embodiments, the piece of data may not match the type of the table of the target database during writing. For example, the data type of column 2 in Table 1 is an integer type while in a written piece of data, a value corresponding to column 3 is of a floating-point type, and the data types thereof conflict with each other. In this case, this piece of data is dirty data.

In some embodiments of the present application, in DataX, the foregoing SlaveContainer module may load a corresponding type of writer plug-in according to the type of the target database. The writer plug-in can synchronize, to the target database, the to-be-synchronized data which is converted from the source data.

In some embodiments of the present application, step 130 may include a sub-step A131.

In sub-step A131, it is determined whether dirty data has been detected when the to-be-synchronized data is synchronized to the target database by means of batch transmission. If dirty data has been detected, sub-step A132 can be performed.

It should be noted that, on the basis of step 101, step A131 to step A135 may be performed by the sub-tasks.

In sub-step A132, the target database is notified to roll back the synchronized data in the to-be-synchronized data.

For example, a batch of source data to be synchronized is the first 10,000 pieces of data in Table 1, and 10,000 pieces of to-be-synchronized data are obtained after conversion. In embodiments of the present application, after dirty data is discovered, a roll-back instruction can be sent to the target database, and the roll-back instruction can include a roll-back object, such as the 10,000 pieces of to-be-synchronized data of Table 1. Then, the database may roll back the synchronized data in the 10,000 pieces of data, till a situation where none of the 10,000 pieces of data is synchronized.

In sub-step A133, the to-be-synchronized data can be synchronized to the target database by means of piece-by-piece transmission after it is determined that the target database finishes roll-back, and it is determined whether date currently being transmitted is dirty data. If the data currently being transmitted is the dirty data, sub-step A134 may be performed. If data currently being transmitted is not dirty data, sub-step A135 may be performed.

In some embodiments of the present application, the present application may store, in a cache, the to-be-synchronized data converted from the source data, and then after it is determined that the target database finishes roll-back, extract to-be-synchronized data from the system cache piece by piece, and synchronize the to-be-synchronized data to the target database by means of piece-by-piece transmission. Therefore, the process of synchronizing the to-be-synchronized data to the target database by means of piece-by-piece transmission is implemented.

Then, if a piece of data being transmitted is dirty data, synchronization of the piece of data may be stopped, and sub-step 134 can be performed to directly record this piece of dirty data. If the piece of data being transmitted is not dirty data, the synchronization succeeds, and a next piece of data can be extracted for synchronization.

In sub-step A134, the dirty data can be recorded, and step A140 can be performed.

It is appreciated that, during recording of the dirty data, the form of the source data thereof may be recorded, or the form of the to-be-synchronized data thereof converted from the source data may be recorded.

This process can be repeated, till processing on this batch of to-be-synchronized data is finished.

In some embodiments, multiple pieces of source data (e.g., 10,000 pieces of source data) may be acquired. The source data can be converted into to-be-synchronized data adaptive to a data meta structure of the target database. Then, to enhance synchronization efficiency, this batch of to-be-synchronized data may be synchronized to the target database by means of batch transmission. In this manner, the batch of data can be written into the target database by means of only one interaction with the target database. Therefore, this manner uses a small quantity of resources and takes a short time. If the data is synchronized to the target database by means of piece-by-piece transmission, on the other hand, it is necessary to interact with the target database each time a piece of data is written, thus occupying many resources and taking a long time.

Thus, in embodiments of the present application, if it is determined that dirty data has been detected during batch transmission (for example, the target database returns the above error), the batch transmission may be terminated after the error has been detected and the synchronization cannot be continued. In this case, in embodiments of the present application, dirty data may be located by means of the process of sub-steps A132 to A135, and then operations, such as recording the dirty data, may be performed.

In step 140, if dirty data has been detected, to-be-synchronized data after the dirty data is continued to be synchronized. In embodiments of the present application, after dirty data has been detected, the synchronization program may not be exited, and to-be-synchronized data after the dirty data is continued to be synchronized.

In some embodiments of the present application, the method can further include a step 150. In step 150, a dirty data list for all dirty data that has been detected can be generated and presented.

In embodiments of the present application, a fault tolerant mechanism may be preset. The fault tolerant mechanism can prevent dirty data from affecting the synchronization process. It is unnecessary to exit the program when dirty data is detected during the synchronization process, so that synchronization can be continued, thus reducing the waste of machine resources and reducing synchronization time.

In addition, in embodiments of the present application, all dirty data that has been detected may be recorded, thus improving a dirty data recognition capability.

Moreover, in embodiments of the present application, the synchronization process may be implemented by using a DataX frame. The DataX frame can implement synchronization between any two relational databases, thus achieving high universality, high synchronization efficiency, and low maintenance costs.

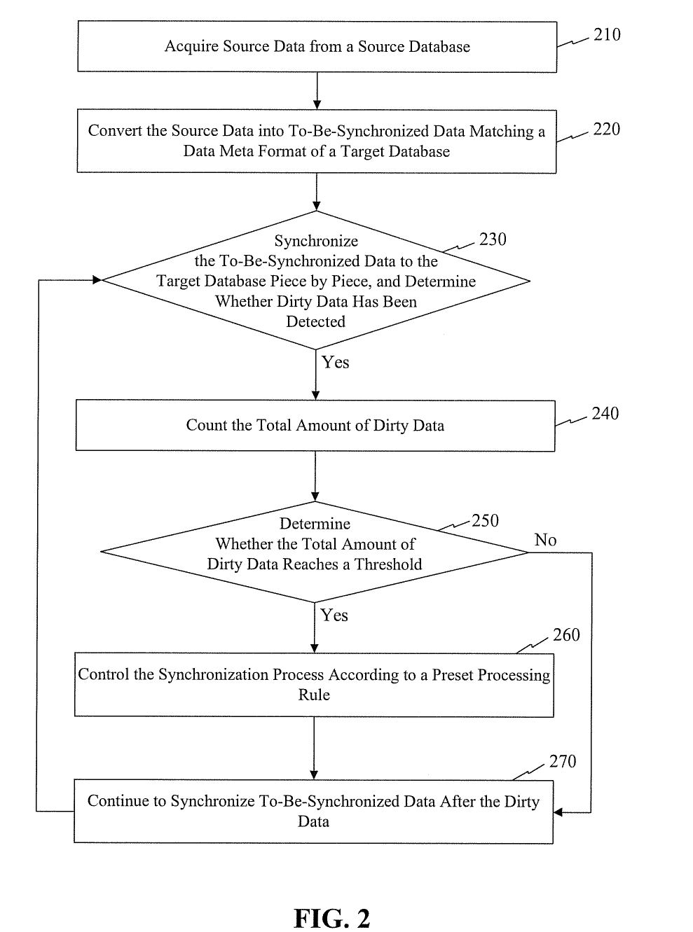

FIG. 2 is flowchart another exemplary data synchronization method according to embodiments of the present application. The method may include the following steps 210-270.

In step 210, source data can be acquired from a source database.

Similar to embodiments as shown in FIG. 1, before step 210, embodiments of the present application can further include a step 201.

In step 201, a synchronization job task can be decomposed into at least two sub-tasks.

Similarly, on the basis of step 101, in some embodiments of the present application, step 210 can include a sub-step A211. In sub-step A211, each sub-task can acquire, from the database, source data to be processed by the sub-task itself.

In step 220, the source data can be converted into to-be-synchronized data matching a data meta format of a target database.

In step 230, the to-be-synchronized data can be synchronized to the target database piece by piece, and it can be determined whether dirty data has been detected. If the dirty data has been detected, step 240 can be performed.

In step 240, the total amount of dirty data can be counted. For dirty data that has been detected during synchronization, the total amount of all dirty data that occur during the synchronization process may be counted. For example, one million pieces of source data need to be synchronized, and the one million pieces of data are synchronized piece by piece. In this case, if dirty data is detected during this process, the total amount of dirty data may be counted. For example, the amount of dirty data that appears may be accumulated.

In some embodiments of the present application, on the basis of sub-step A211, step 240 includes a sub-step A241.

In sub-step A241, the total amount of dirty data can be calculated according to the dirty data detected by the sub-tasks. Because each sub-task can independently synchronize the source data acquired by the sub-task itself, a scheduling task may be set in embodiments of the present application to collect dirty data detected by the sub-tasks, thereby calculating the total amount of dirty data.

In some embodiments of the present application, sub-step 241 can include a sub-step A2411 and a sub-step A2412.

In sub-step A2411, polling can be performed to collect dirty data recorded by the sub-tasks. For example, the sub-tasks can be polled periodically (e.g., every 5 minutes), so as to acquire newly recorded dirty data from these sub-tasks.

In sub-step A2412, the collected dirty data can be summarized, and the total amount of dirty data can be calculated. Then, all the collected dirty data may be summarized, thereby obtaining the total amount of dirty data.

In step 250, it can be determined whether the total amount of dirty data reaches a threshold. If the total amount of dirty data does not reach the threshold, step 270 can be performed to continue to synchronize to-be-synchronized data after the dirty data. If the total amount of dirty data reaches the threshold, step 260 can be performed.

In step 260, the synchronization process can be controlled according to a preset processing rule.

In step 270, to-be-synchronized data after the dirty data can be continued to be synchronized. If the total amount of dirty data reaches the threshold, the synchronization process may be controlled according to a preset processing rule. The processing rule may include any of the following actions. For example, the action can include exiting the synchronization process. The action can also include in response to the current total amount of dirty data reaching the threshold but to-be-synchronized data still being currently synchronized, allowing no further synchronization after synchronization of such to-be-synchronized data is finished.

In embodiments of the present application, after the step of summarizing the collected dirty data, the method may further include a step 280.

In step 280, a dirty data list of the summarized dirty data can be generated and presented.

In embodiments of the present application, a dirty data list for the summarized dirty data may be generated and presented in a client terminal, so that technicians can conveniently check where dirty data has been detected.

In embodiments of the present application, another fault tolerant mechanism may be set. A dirty data threshold that has relatively small impact on subsequent processing may be preset. For example, if the amount of to-be-synchronized data is 10 million, the threshold may be set to 1,000. When source data in a source database is synchronized to a target database and dirty data is detected during the synchronization process, the total amount of dirty data may be counted. The total amount of the dirty data can be compared with the preset threshold. If the total amount of dirty data does not reach the threshold, synchronization may be continued, and it is unnecessary to exit the synchronization program. Therefore, synchronization can be continued, thereby reducing the waste of machine resources, reducing synchronization time, and timely limiting an excessively large amount of dirty data, so that the technicians can reconfigure a conversion rule.

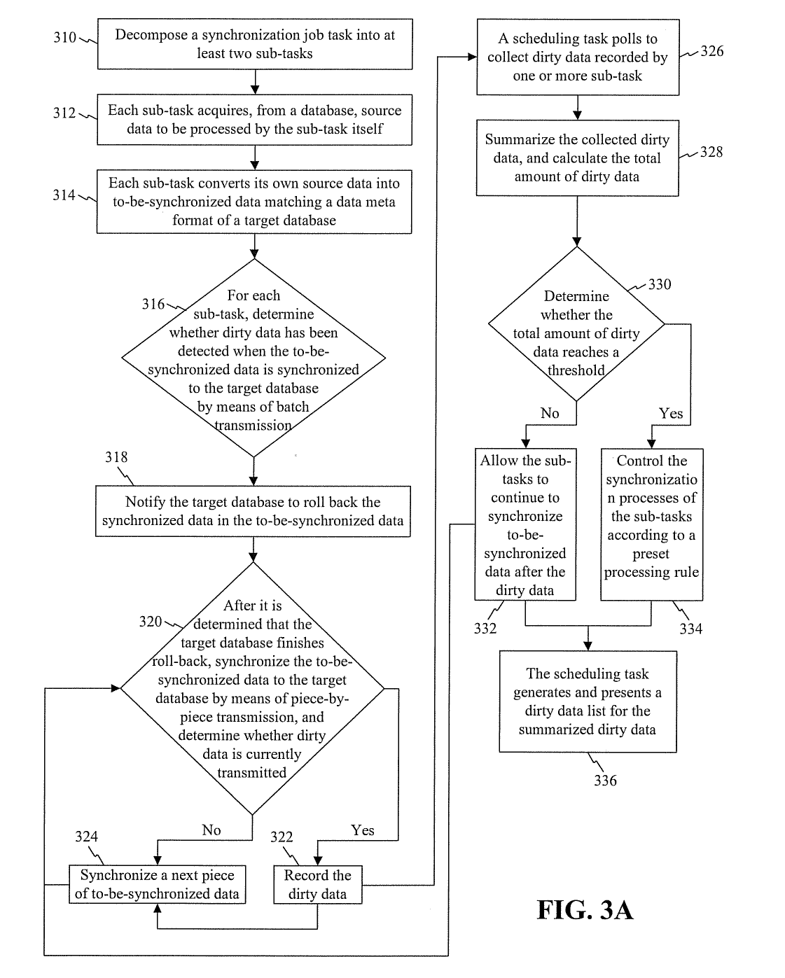

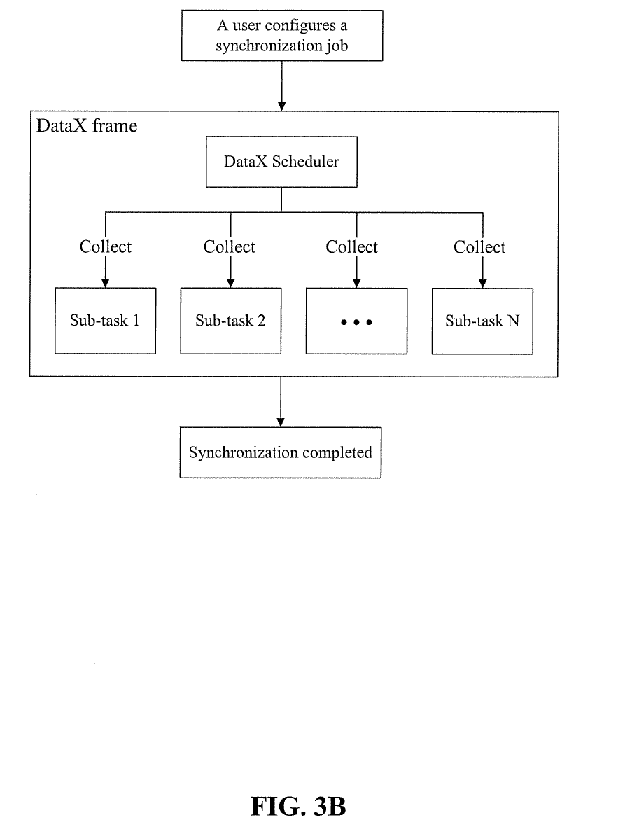

To illustrate embodiments of the present invention more clearly and conveniently, embodiments of the present application are described hereinafter by using embodiments in FIG. 3A with reference to a multi-task processing architecture of the present invention.

FIG. 3A is a flowchart of yet another data synchronization method according to embodiments of the present application. The method may include the following steps 310-336.

In step 310, a synchronization job task is decomposed into at least two sub-tasks.

With reference to FIG. 3B, a user may configure a synchronization job for a DataX frame. Then, in the DataX frame, the synchronization job task can be decomposed into N sub-tasks. These tasks are controlled by a DataX Scheduler (a scheduling task of DataX), till the synchronization is finished.

With reference back to FIG. 3A, in step 312, each sub-task can acquire, from a database, source data to be processed by the sub-task itself.

In step 314, each sub-task can convert its own source data into to-be-synchronized data matching a data meta format of a target database.

In step 316, for each sub-task, when the to-be-synchronized data is synchronized to the target database by means of batch transmission, it can be determined whether dirty data has been detected. If dirty data has been detected, step 318 can be performed.

In step 318, the target database can be notified to roll back the synchronized data in the to-be-synchronized data, and step 320 can be performed.

In step 320, after it is determined that the target database finishes rolling back, the to-be-synchronized data can be synchronized to the target database by means of piece-by-piece transmission, and it can be determined whether the dirty data is currently being transmitted. If the dirty data is currently being transmitted, step 322 can be performed. If the data being currently transmitted is not dirty data, step 324 can be performed.

If the data being currently transmitted is not dirty data, a next piece of to-be-synchronized data can be synchronized to the target database by means of piece-by-piece transmission.

In step 322, the dirty data can be recorded, and steps 324 and 326 are performed.

In step 324, a next piece of to-be-synchronized data can be synchronized, and step 320 can be performed.

Step 322 may be interpreted as continuing to synchronize to-be-synchronized data after the dirty data is recorded.

In embodiments of the present application, steps 314 to 324 can be performed by the sub-tasks.

In step 326, a scheduling task can poll to collect dirty data recorded by one or more sub-tasks. As shown in FIG. 3B, the DataX Scheduler can periodically collect new dirty data recorded by sub-task 1 to sub-task N.

In step 328, the collected dirty data can be summarized, and the total amount of dirty data can be calculated.

Then, the DataX Scheduler may summarize the collected dirty data and calculate the total amount of the summarized dirty data.

In embodiments of the present application, the summarized dirty data may be stored, for example, at a specified location in a magnetic disk.

In step 330, it is determined whether the total amount of dirty data reaches a threshold. If the total amount of dirty data does not reach the threshold, step 332 can be performed. If the total amount of dirty data reaches the threshold, step 334 can be performed.

In step 332, the sub-tasks can continue to synchronize to-be-synchronized data located after the dirty data. Step 320 and step 336 can be performed.

In step 334, the synchronization processes of the sub-tasks can be controlled according to a preset processing rule, and step 336 can be performed.

If the total amount of dirty data reaches the threshold, the synchronization processes can be controlled according to the preset processing rule. The processing rule may include any of the following actions. The actions can include the sub-tasks exiting the synchronization processes. The actions can also include in response to the current total amount of the dirty data reaching the threshold and sub-tasks still synchronizing to-be-synchronized data currently, not allowing the sub-tasks to perform synchronization after finishing synchronization of the currently processed to-be-synchronized data.

In step 336, the scheduling task can generate and present a dirty data list for the summarized dirty data.

In some embodiments of the present application, the dirty data list may be presented after the synchronization in FIG. 3B has finished, or may be presented after the synchronization process is terminated.

In embodiments of the present application, some steps may be exchanged according to actual requirements, which is not limited by information of the present application.

The following problems mainly need to be considered for synchronization between heterogeneous data sources, such as standard data transmission protocol, ensuring data consistency, and providing a fault tolerant mechanism.

In a heterogeneous data environment, data types of different data storages are different and limited. It can be difficult to stipulate a set of standard data transmission protocols to implement conversion between data types of heterogeneous storage structures. If the data transmission protocols are not the same and a data type of a data source is different from that of a destination end, a synchronization job may fail.

Data synchronization can be performed for the purpose of data processing and summarization. To guarantee the consistency between source data and synchronization target data, dirty data can be effectively recognized during the synchronization process, and fed back to a user.

Synchronization of big data can cost a relatively large quantity of resources. When conventional synchronization techniques fail based on the encountering of dirty data, a great quantity of resources are inevitably wasted.

Based on the foregoing considerations, in embodiments of the present application, a fault tolerant mechanism for dirty data can be set first. For example, a dirty data threshold that has relatively small impact on subsequent processing can be preset. If the amount of to-be-synchronized data is 10 million, the threshold may be set to 1,000. When source data in a source database is synchronized to a target database and dirty data is detected during the synchronization process, the total amount of dirty data may be counted. The dirty data can be compared with the preset threshold. If the total amount of dirty data does not reach the threshold, synchronization may be continued, and it is unnecessary to exit the synchronization program. Therefore, synchronization can be continued, thereby reducing the waste of machine resources and reducing synchronization time.

Moreover, based on the fault tolerant mechanism, embodiments of the present application may record various dirty data that is detected during the synchronization process, thereby improving a dirty data recognition capability. Conventionally, however, only one piece of dirty data in the current batch submission process can be recognized.

Finally, embodiments of the present application may employ a DataX frame. The DataX frame has a set of standard transmission protocols, and can easily implement synchronization between any two relational databases, thus achieving high universality, high synchronization efficiency, and low maintenance costs.

It should be noted that, for ease of description, the method embodiments are all expressed as combinations of a series of actions. However, it is appreciated that embodiments of the present application are not limited by the described order of actions. Some steps may be performed in another order or simultaneously. Further, the actions in embodiments of the present application are not necessarily mandatory to embodiments.

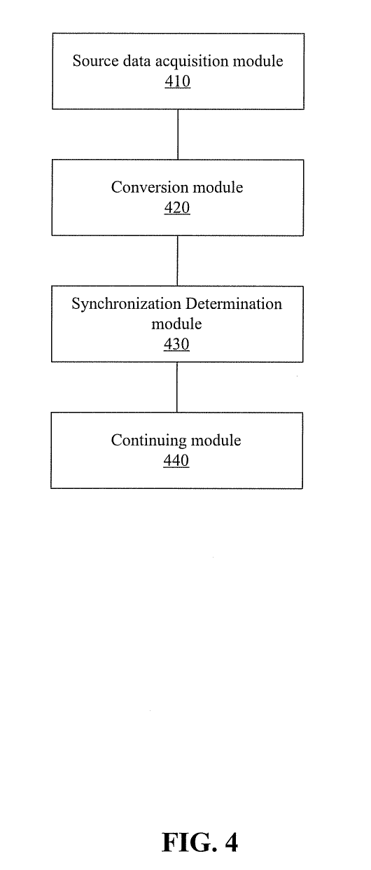

FIG. 4 illustrates a structural block diagram of a data synchronization apparatus according to embodiments of the present application. The apparatus may include the following modules 410-440.

A source data acquisition module 410 can be configured to acquire source data from a source database.

A conversion module 420 can be configured to convert the source data into to-be-synchronized data matching a data meta format of a target database.

A synchronization determination module 430 can be configured to synchronize the to-be-synchronized data to the target database piece by piece, and determine whether dirty data has been detected.

A continuing module can be configured 440 to continue, if dirty data has been detected, to synchronize to-be-synchronized data located after the dirty data.

In embodiments of the present application, the apparatus further includes a dirty data counting module, a dirty data amount determination module, and a synchronization control module.

The dirty data counting module can be configured to count the total amount of dirty data if the dirty data has been detected;

The dirty data amount determination module can be configured to determine whether the total amount of dirty data reaches a threshold, and proceed to the continuing module 440 if the total amount of dirty data does not reach the threshold.

The synchronization control module can be configured to control the synchronization process according to a preset processing rule if the total amount of dirty data reaches the threshold.

In some embodiments of the present application, the synchronization determination module 430 can include: a batch data synchronization sub-module, a roll-back notification sub-module, and a single-piece data synchronization sub-module.

The batch data synchronization sub-module can be configured to determine whether the dirty data has been detected when the to-be-synchronized data is synchronized to the target database by means of batch transmission, and proceed to a roll-back notification sub-module if dirty data has been detected.

The roll-back notification sub-module can be configured to notify the target database to roll back the synchronized data in the to-be-synchronized data.

The single-piece data synchronization sub-module can be configured to synchronize the to-be-synchronized data to the target database by means of piece-by-piece transmission after it is determined that the target database finishes roll-back, and determine whether dirty data is currently being transmitted.

If it is determined that dirty data is currently being transmitted, the process proceeds to a dirty data recording module.

Further, in some embodiments of the present application, the apparatus further includes: a dirty data recording module. The dirty data recording module can be configured to: in response to the dirty data being detected, record the dirty data.

In some embodiments of the present application, the apparatus further includes: a task decomposition module. The task decomposition module can be configured to decompose a synchronization job task into at least two sub-tasks.

Further, in some embodiments of the present application, source data acquisition module 410 includes: a source data acquisition sub-module. The source data acquisition sub-module can be configured to enable each sub-task to acquire, from the database, source data to be processed by the sub-task itself.

Further, in some embodiments of the present application, the dirty data counting module includes: a dirty data counting sub-module. The dirty data counting sub-module can be configured to calculate the total amount of dirty data according to dirty data found by the sub-tasks.

Further, in some embodiments of the present application, the dirty data counting sub-module includes: a polling and collection sub-module and a summarizing sub-module. The polling and collection sub-module can be configured to periodically poll to collect dirty data recorded by the sub-tasks. The summarizing sub-module can be configured to summarize the collected dirty data, and calculate the total amount of the dirty data.

In some embodiments of the present application, after the summarizing sub-module, the apparatus further includes: a presentation module The presentation module can be configured to generate and present a dirty data list for the summarized dirty data.

In some embodiments of the present application, the apparatus further includes: a pre-detection module. The pre-detection module can be configured to pre-detect the to-be-synchronized data to filter out dirty data in the to-be-synchronized data.

In some embodiments of the present application, the source database can be any type of relational database, and the target database can be any type of relational database.

Therefore, in some embodiments of the present application, a fault tolerant mechanism may be preset. The fault tolerant mechanism can prevent dirty data from affecting the synchronization process. It is unnecessary to exit the program once dirty data is detected during the synchronization process, so that synchronization can be continued, thus reducing the waste of machine resources and reducing synchronization time.

In addition, embodiments of the present application may record all dirty data that has been detected, thus improving a dirty data recognition capability.

Moreover, in embodiments of the present application, the synchronization process may be implemented by using a DataX frame. The DataX frame can easily implement synchronization between any two relational databases, thus achieving high universality, high synchronization efficiency, and low maintenance costs.

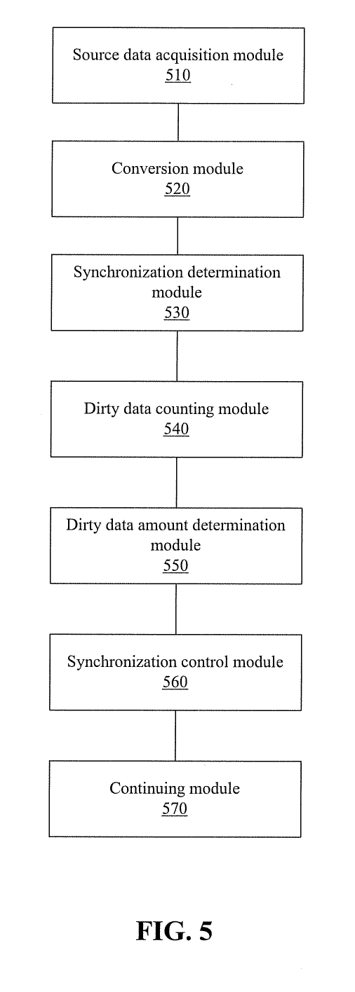

FIG. 5 illustrates a structural block diagram of another exemplary data synchronization apparatus according to embodiments of the present application. The apparatus may include the following modules: a source data acquisition module 510, a conversion module 520, a synchronization judgment module 530, a dirty data counting module 540, a dirty data amount judgment module 550, a synchronization control module 560, and a continuing module 570.

Source data acquisition module 510 can be configured to acquire source data from a source database.

Conversion module 520 can be configured to convert the source data into to-be-synchronized data matching a data meta format of a target database.

Synchronization determination module 530 can be configured to synchronize the to-be-synchronized data to the target database piece by piece, and determine whether dirty data has been detected.

Dirty data counting module 540 can be configured to count the total amount of dirty data if the dirty data has been detected.

Dirty data amount determination module 550 can be configured to determine whether the total amount of dirty data reaches a threshold. Continuing module 570 can be called if the total amount of dirty data does not reach the threshold. And synchronization control module 560 can be called if the total amount of dirty data reaches the threshold.

Synchronization control module 560 can be configured to control the synchronization process according to a preset processing rule.

Continuing module 570 can be configured to continue to synchronize to-be-synchronized data after the dirty data.

In embodiments of the present application, another fault tolerant mechanism may be set. A dirty data threshold that has relatively small impact on subsequent processing may be preset. For example, if the amount of to-be-synchronized data is 10 million, the threshold may be set to 1,000. When source data in a source database is synchronized to a target database and dirty data is detected during the synchronization process, the total amount of dirty data may be counted. The dirty data is compared with the preset threshold. If the total amount of dirty data does not reach the threshold, synchronization may be continued, and it is unnecessary to exit the synchronization program. Therefore, synchronization can be continued, thereby reducing the waste of machine resources, reducing synchronization time, and timely limiting an excessively large amount of dirty data, so that the technicians can reconfigure a conversion rule.

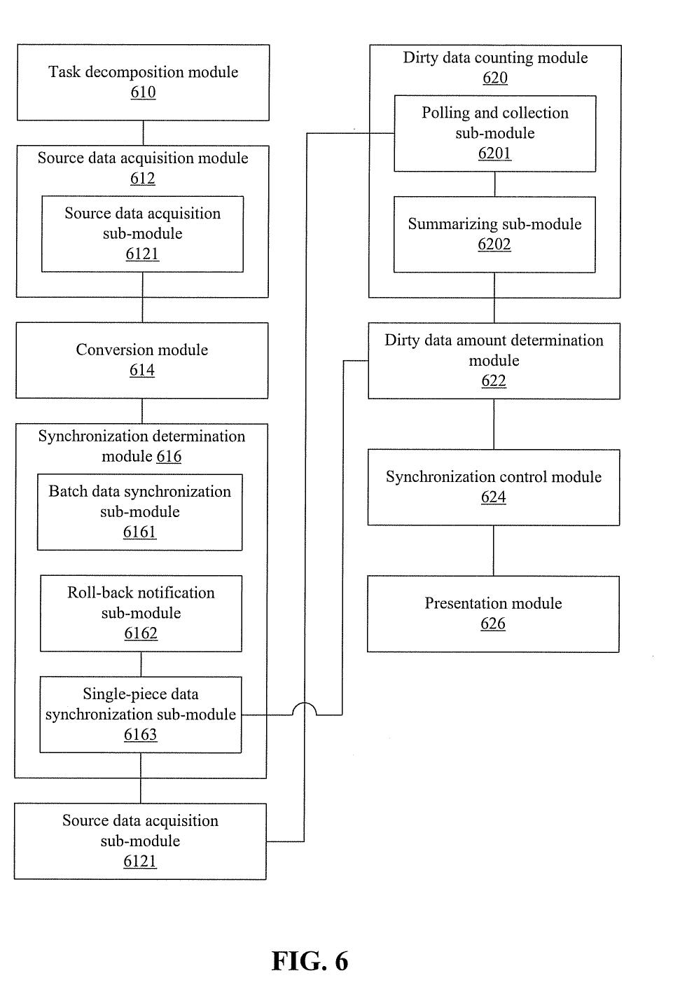

FIG. 6 illustrates a structural block diagram of another exemplary data synchronization apparatus according to the present application. The apparatus may include the following modules 610-626.

A task decomposition module 610 can be configured to decompose a synchronization job task into at least two sub-tasks.

A source data acquisition module 612 can further include a source data acquisition sub-module 6121. Source data acquisition sub-module 6121 can be configured to enable each sub-task to separately acquire, from a database, source data to be processed by the sub-task itself.

A conversion module 614 can be configured to convert the source data into to-be-synchronized data matching a data meta format of a target database.

A synchronization determination module 616 can further includes: a batch data synchronization sub-module 6161, a roll-back notification sub-module 6162, and a single-piece data synchronization sub-module 6163.

Batch data synchronization sub-module 6161 can be configured to determine whether dirty data has been detected when the to-be-synchronized data is synchronized to the target database by means of batch transmission; and proceed to roll-back notification sub-module 6162 if dirty data has been detected.

Roll-back notification sub-module 6162 can be configured to notify the target database to roll back the synchronized data in the to-be-synchronized data.

Single-piece data synchronization sub-module 6163 can be configured to synchronize the to-be-synchronized data to the target database by means of piece-by-piece transmission after it is determined that the target database finishes roll-back, and determine whether dirty data is currently being transmitted, proceed to dirty data recording module 618 if dirty data has been detected, and synchronize a next piece of to-be-synchronized data if no dirty data has been detected;

Dirty data recording module 618 can be configured to record the dirty data; and proceed to single-piece data synchronization sub-module 6163 and a polling and collection sub-module 6201. If no dirty data has been detected, single-piece data synchronization sub-module 6163 continues to synchronize a next piece of to-be-synchronized data.

Dirty data counting module 620 can include a polling and collection sub-module 6201 and a summarizing sub-module 6202. Polling and collection sub-module 6201 can be configured to periodically poll to collect dirty data recorded by the sub-tasks. Summarizing sub-module 6202 can be configured to summarize the collected dirty data, and calculate the total amount of dirty data.

Dirty data amount judgment module 622 can be configured to determine whether the total amount of dirty data reaches a threshold. If the total amount of dirty data does not reach the threshold, the sub-tasks can continue to synchronize to-be-synchronized data after the dirty data, and proceed to single-piece data synchronization sub-module 6163. And if the total amount of dirty data reaches the threshold, proceed to a synchronization control module 624.

Synchronization control module 624 can be configured to control the synchronization process according to a preset processing rule.

A presentation module 626 can be configured to generate and present a dirty data list for the summarized dirty data.

The above apparatus can provide functionality similar to the functionality of the method described earlier, and therefore is described in a relatively simple manner. For related parts, reference may be made to the description in embodiments for the method.

In embodiments of the present application, a fault tolerant mechanism for dirty data is set first. That is, a dirty data threshold that has relatively small impact on subsequent processing is preset. For example, if the amount of to-be-synchronized data is 10 million, the threshold may be set to 1,000. Source data in a source database can be synchronized to a target database. If dirty data is detected during the synchronization process, the total amount of dirty data may be counted. The dirty data is compared with the preset threshold. If the total amount of dirty data does not reach the threshold, synchronization may be continued, and it is unnecessary to exit the synchronization program. In this way, synchronization can be continued, thereby reducing the waste of machine resources and reducing synchronization time.

Moreover, based on the fault tolerant mechanism, embodiments of the present application may record various dirty data that are detected during the synchronization process, thereby improving a dirty data recognition capability.

Finally, embodiments of the present application may employ a DataX frame. The DataX frame has a set of standard transmission protocols, and can easily implement synchronization between any two relational databases, thus achieving high universality, high synchronization efficiency, and low maintenance costs.

Embodiments of the present application are described progressively, each embodiment emphasizes a part different from other embodiments, and identical or similar parts of embodiments may be obtained with reference to each other.

It is appreciated that embodiments of the present application may be provided as a method, an apparatus, or a computer program product. Therefore, embodiments of the present application may be implemented as a complete hardware embodiment, a complete software embodiment, or an embodiment combining software and hardware. Moreover, embodiments of the present application may be a computer program product implemented on one or more computer usable storage media (including, but not limited to, a magnetic disk memory, a CD-ROM, an optical memory, and the like) including computer usable program codes.

In a typical configuration, the computer device includes one or more processors (CPUs), an input/output interface, a network interface, and a memory. The memory may include computer readable media such as a volatile memory, a Random Access Memory (RAM), and/or non-volatile memory, e.g., Read-Only Memory (ROM) or flash RAM. The memory is an example of a computer readable medium. The computer readable medium includes non-volatile and volatile media as well as movable and non-movable media, and can implement information storage by means of any method or technology. Information may be a computer readable instruction, a data structure, and a module of a program or other data. An example of the storage medium of a computer includes, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and can be used to store information accessible to a computing device. According to the definition herein, the computer readable medium does not include transitory media, such as a modulated data signal and a carrier.

The embodiments of the present application are described with reference to flow charts and/or block diagrams of the method, terminal device (system) and computer program product according to embodiments of the present application. It should be understood that a computer program instruction may be used to implement each process and/or block in the flowcharts and/or block diagrams and combinations of processes and/or blocks in the flowcharts and/or block diagrams. The computer program instructions may be provided to a universal computer, a dedicated computer, an embedded processor or a processor of another programmable data processing terminal device to generate a machine, such that the computer or a processor of another programmable data processing terminal device executes an instruction to generate an apparatus configured to implement functions designated in one or more processes in the flowcharts and/or one or more blocks in the block diagrams.

These computer program instructions may also be stored in a computer readable memory that can instruct the computer or any other programmable data processing device to work in a specific manner, such that the instructions stored in the computer readable memory generate an article of manufacture that includes an instruction apparatus. The instruction apparatus implements a designated function in one or more processes in the flowcharts and/or in one or more blocks in the block diagrams.

These computer program instructions may also be loaded onto a computer or another programmable data processing terminal device, such that a series of operation steps are executed on the computer or another programmable terminal device to generate computer implemented processing. Therefore, the instructions executed in the computer or another programmable terminal device provide steps for implementing designated functions in one or more processes in the flowcharts and/or one or more blocks in the block diagrams.

The appended claims are intended to be explained as including all variations and modifications falling within the scope of embodiments of the present application.

Finally, it should be further noted that, in this text, the relation terms such as first and second are merely used to distinguish one entity or operation from another entity or operation, and do not necessarily require or imply that the entities or operations have this actual relation or order. Moreover, the terms “include”, “comprise” or any other variations thereof are intended to cover non-exclusive inclusion, so that a process, a method, an article or a terminal device including a series of elements not only includes the elements, but also includes other elements not clearly listed, or further includes inherent elements of the process, method, article or terminal device. In a case without any more limitations, an element defined by “including a/an . . . ” does not exclude that the process, method, article or terminal device including the element further has other identical elements.

A data synchronization method and a data synchronization apparatus provided in the present application are described in detail above, and the principles and implementations of the present application are described by applying specific examples in this text. The above description of embodiments is merely used to help understand the method of the present application and core ideas thereof. Meanwhile, it is appreciated that modifications may be made to the specific implementations and application scopes according to the idea of the present application. Therefore, the content of the specification should not be construed as any limitation to the present application.

1. A data synchronization method, comprising:
acquiring source data from a source database;
converting the source data into to-be-synchronized data matching a data meta format of a target database;
synchronizing the to-be-synchronized data to the target database;
determining whether dirty data has been detected during the synchronization; and
in response to the dirty data being detected during the synchronization, skipping the detected dirty data to continue with synchronizing the to-be-synchronized data.

2. The method according to claim 1, wherein before skipping the detected dirty data to continue with synchronizing the to-be-synchronized data, the method further comprises:
counting a total amount of dirty data;
determining whether the total amount of dirty data reaches a threshold; and
continuing with synchronization in response to the total amount of dirty data not reaching the threshold.

3. The method according to claim 1, further comprising:
synchronizing the to-be-synchronized data to the target database in a batch including a plurality of pieces;
determining whether the dirty data has been detected in the batch;
notifying, in response to the dirty data being detected in the batch, the target database to roll back the synchronized data in the to-be-synchronized data; and
synchronizing the to-be-synchronized data to the target database based on a piece-by-piece transmission after the target database rolls back; and
determining whether a transmitted piece of data includes the dirty data.

4. The method according to claim 3, further comprising:
in response to the transmitted piece of data including the dirty data, recording the transmitted piece of data as the dirty data.

5. The method according to claim 2, further comprising:
decomposing a synchronization job task into at least two sub-tasks.

6. The method according to claim 5, wherein acquiring source data from a source database further comprises:
acquiring, by each sub-task from the database, source data to be processed by the sub-task itself.

7. The method according to claim 5, wherein counting the total amount of dirty data further comprises:
determining the total amount of dirty data according to the dirty data detected by the sub-tasks.

8. The method according to claim 7, wherein determining the total amount of dirty data according to the dirty data detected by the sub-tasks further comprises:
performing polling on the sub-tasks to collect recorded dirty data; and
summarizing polling results to generate the total amount of dirty data.

9. The method according to claim 8, further comprising:
generating a dirty data list based on the summarized dirty data.

10. The method according to claim 1, further comprising:
pre-detecting the to-be-synchronized data to filter out dirty data in the to-be-synchronized data.

11. The method according to claim 1, wherein the source database is a relational database, and the target database is a relational database.

12. A data synchronization apparatus, comprising:
a source data acquisition module configured to acquire source data from a source database;
a conversion module configured to convert the source data into to-be-synchronized data matching a data meta format of a target database;
a synchronization determination module configured to synchronize the to-be-synchronized data to the target database, and determine whether dirty data has been detected during the synchronization; and
a continuing module configured to skip the detected dirty data to continue with synchronizing the to-be-synchronized data, in response to dirty data being detected.

13. The apparatus according to claim 12, further comprising:
a dirty data counting module configured to count a total amount of dirty data;
a dirty data amount determination module configured to determine whether the total amount of dirty data reaches a threshold; and
a synchronization control module configured to control the synchronization process according to a preset processing rule if the total amount of dirty data reaches the threshold.

14. The apparatus according to claim 12, wherein the synchronization determination module comprises:
a batch data synchronization sub-module configured to synchronize the to-be-synchronized data to the target database in a batch including a plurality of pieces, and determine whether the dirty data has been detected in the batch;
a roll-back notification sub-module configured to notify, in response to the dirty data being detected in the batch, the target database to roll back the synchronized data in the to-be-synchronized data; and
a single-piece data synchronization sub-module configured to synchronize the to-be-synchronized data to the target database based on a piece-by-piece transmission after the target database rolls back, and determine whether a transmitted piece of data including the dirty data.

15. The apparatus according to claim 12, further comprising:
a dirty data recording module configured to: in response to the transmitted piece of data including the dirty data, record the transmitted piece of data as the dirty data.

16. The apparatus according to claim 13, further comprising:
a task decomposition module configured to decompose a synchronization job task into at least two sub-tasks.

17. The apparatus according to claim 16, wherein the source data acquisition module comprises:
a source data acquisition sub-module configured to enable each sub-task to acquire, from the database, source data to be processed by the sub-task itself.

18. The apparatus according to claim 16, wherein the dirty data counting module comprises:
a dirty data counting sub-module configured to determine the total amount of dirty data according to the dirty data detected by the sub-tasks.

19. The apparatus according to claim 17, wherein the dirty data counting sub-module comprises:
a polling and collection sub-module configured to perform polling on the sub-tasks to collect recorded dirty data; and
a summarizing sub-module configured to summarize polling results to generate the total amount of dirty data.

20-22. (canceled)

23. A non-transitory computer readable medium that stores a set of instructions that is executable by at least one processor of a computing system to cause the computing system to perform a data synchronization method, the method comprising:
acquiring source data from a source database;
converting the source data into to-be-synchronized data matching a data meta format of a target database;
synchronizing the to-be-synchronized data to the target database;
determining whether dirty data has been detected during the synchronization; and
in response to the dirty data being detected during the synchronization, skipping the detected dirty data to continue with synchronizing the to-be-synchronized data.

24-33. (canceled)
